(19) United States
(12) Patent Application Publication
(10) Pub. No.: US 2003/0169698 A1
(43) Pub. Date: Sep. 11, 2003

(54) Wireless atm network

(76) Inventors: Rahim Tafazolli, Surrey (GB); Georgios Sfikas, Glyfada (GR)

Correspondence Address: LEYDIG VOIT & MAYER, LTD, TWO PRUDENTIAL PLAZA, SUITE 4900, 180 NORTH STETSON AVENUE, CHICAGO, IL, 60601-6780, US

(21) Appl. No.: 10/257,699

(22) PCT Filed: Apr. 19, 2001
(86) PCT No.: PCT/GB01/01768

(30) Foreign Application Priority Data
Apr. 20, 2000 (GB) 0009889.7

(51) Int. Cl. H04B 7/00

(52) U.S. Cl. 370/310.1; 370/395.1

(57) ABSTRACT

A method of transmitting non-real-time data over a wireless link from a terminal (2) to an ATM switch (6) comprising the steps of generating in the terminal (2), a plurality of ATM cells derived from a protocol data unit, marking the last ATM cell of the protocol data unit, sequentially transmitting the ATM cells over the wireless link, determining in the ATM switch for each transmitted cell, whether that cell contains an error, and sending an error message back to the terminal if an ATM cell is determined to contain an error, the terminal (2) being arranged on receipt of the error message, to cease transmitting any remaining ATM cells of the protocol data unit from which the erroneous ATM cell was derived. Also, an ATM protocol stack for wireless ATM communications in which the physical layer below the ATM layer, has been adapted to include a radio access layer, the radio access layer including a medium access control protocol layer and a partial packet discard mechanism.

This invention relates to a method of transmitting data over a wireless link and to an Asynchronous Transfer Mode (ATM) protocol stack for wireless ATM communications.

In accordance with a first aspect of the invention there is provided a method of transmitting non-real-time data over a wireless link from a terminal to an ATM switch comprising the steps of generating in the terminal, a plurality of ATM cells derived from a protocol data unit, marking the last ATM cell of the protocol data unit, sequentially transmitting the ATM cells over the wireless link, determining in the ATM switch for each transmitted cell, whether that cell contains an error, and sending an error message back to the terminal if an ATM cell is determined to contain an error, the terminal being arranged on receipt of the error message, to cease transmitting any remaining ATM cells of the protocol data unit from which the erroneous ATM cell was derived.

In accordance with a second aspect of the invention, there is provided an ATM protocol stack for wireless ATM communications in which the physical layer below the ATM layer, has been adapted to include a radio access layer, the radio access layer including a medium access control protocol layer and a partial packet discard mechanism.

Embodiments of ATM protocol stacks in accordance with the invention will now be described by way of example with reference to the drawings in which:

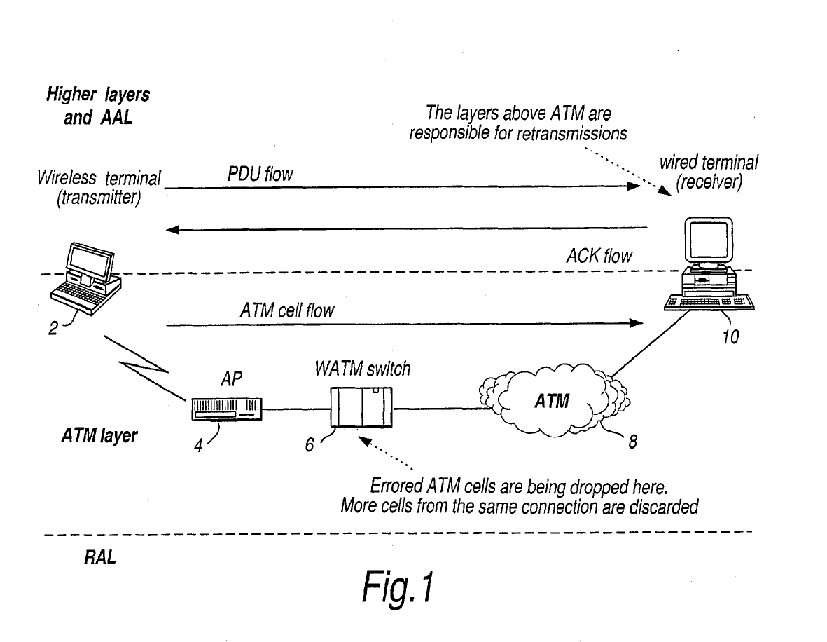

FIG. 1 is a schematic block diagram showing control and data flow for a wireless ATM connection in accordance with the invention;

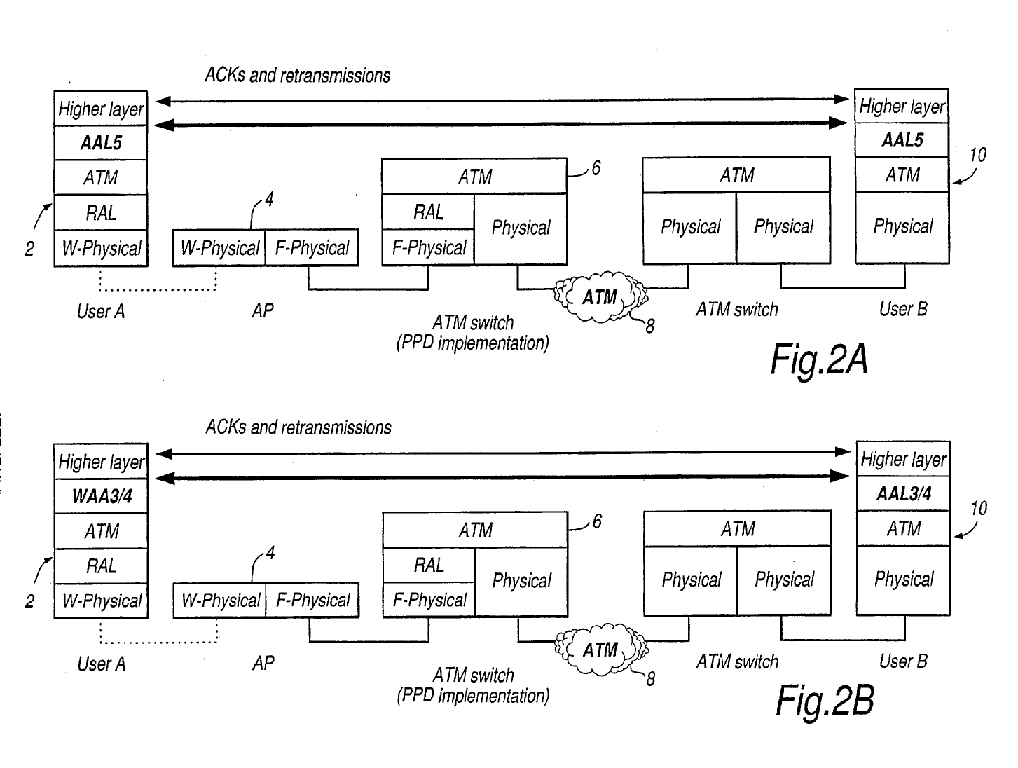

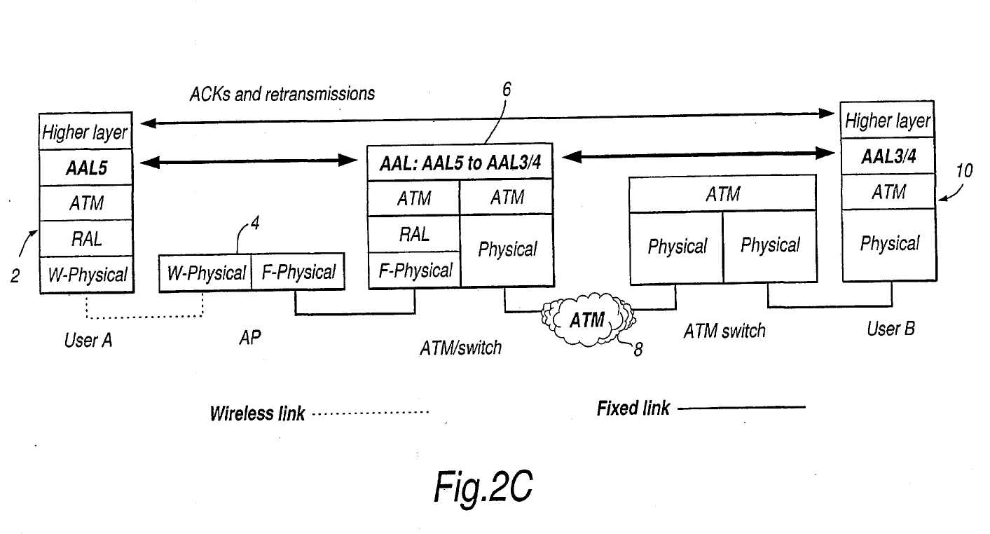

FIG. 2A is a schematic block diagram of the ATM protocol stacks of a first embodiment of the invention;

FIG. 2B is a schematic block diagram of the ATM protocol stacks of a second embodiment of the invention; and

FIG. 2C is a schematic block diagram of the ATM protocol stacks of a third embodiment of the invention.

With reference to FIG. 1, at a physical level, a wireless terminal such as a laptop computer 2, transmits data to an access point 4 on the network such as a base station (AP). This forms the wireless part of the connection. The AP 4 is connected to a “wireless” ATM switch 6 which is shown connected to a schematic network “cloud” 8 which may contain one or more additional ATM switches.

Having passed through the network 8, data passes to a fixed wired terminal 10 such as a desktop computer.

At a high level (higher than the illustrated ATM layer), the ATM protocol stack generates units of data called a “Protocol Data Unit” (PDU). The data contained in the PDU is transmitted from the terminal 2 to the receiver 10 as a plurality of ATM cells. The creation of PDUs is not discussed in detail here.

To transmit the PDUs across an ATM link, the PDUs are mapped to the ATM cells using so-called Adaptation Layer protocols (AAL). Presently, four AALs have been defined (by the ITU-T and the ATM forum) and the present invention is concerned with a wireless implementation of two of these protocols (AAL5 and AAL3/4). These protocols are concerned largely with the transmission of data which is not delay-sensitive (as opposed to voice and constant bit rate services).

In the transmission of AAL5 and AAL3/4-PDUs, a scheme of “Partial Packet Discard” (PPD) has been proposed for a fixed (wired) arrangement, in which an ATM switch discards all cells associated with a particular PDU once an error has been detected in an ATM cell forming part of that PDU. This is used as a basis for the scheme used in the present invention.

It is assumed in the implementation of a PPD scheme that the high level protocols at the receiver 10 are responsible for issuing acknowledgements and requesting re-transmission of PDUs by the terminal 2.

The idea of a PPD mechanism is enhanced in the present invention by reducing traffic on the wireless link between the terminal 2 and the AP 4. To achieve this, when an erroneous ATM cell is detected at the switch 6, a signal is sent back from the switch 6 to the terminal 2 requesting it to cease transmission of any further cells associated with the PDU containing the erroneous ATM cell. In this way, the throughput of the wireless link is greatly improved. It will be noted that the prior art arrangement allows the terminal 2 to continue transmitting the cells associated with the PDU containing the erroneous ATM cells. Thus a large amount of data may be sent by the terminal which is of no use and which is simply discarded by the ATM switch 6. The present invention avoids wasting bandwidth in the wireless link in this way.

With reference to FIG. 2A, an implementation using an AAL 5 protocol from end to end is shown.

The AAL 5 protocol does not support simultaneous multiplexing of packets on a single virtual circuit (VC). Thus since all cells associated with a particular PDU can therefore be assumed to relate to one VC, the so-called ATM layer user to user (AUU) parameter is redundant. The terminal 2 may therefore use the AUU parameter to delineate the boundary between PDUs. This is achieved by setting the AUU parameter in the ATM cell header of the last cell of the PDU which is being transmitted.

Thus at the receiver 10, the end of a particular PDU is detected by checking the AUU parameter in each ATM cell header and looking for a cell in which the AUU parameter is set. Since the receiver 10 expects to see a cell with the AUU parameter set, it is necessary for the switch 6 and the transmitter 2 to cooperate to ensure that the last cell of a particular PDU is transmitted to the receiver 10 even if the rest of the PDU has not been transmitted because it contained an erroneous cell. Thus, preferably the signal returned by the switch 6 to the terminal 2 when an erroneous ATM cell is detected, causes the terminal 2 to cease sending the remaining cells of the PDU except for the last cell. The last cell is transmitted by the terminal and passed onwards by the switch 6 and the network 8.

The header of each cell may be protected using error coding. The error coding may allow errors to be corrected as well as detected. This provides improved efficiency particularly when the first “PPD-aware” switch in the path from the terminal 2 to the terminal 10 is in the cloud 8.

With reference to FIG. 2B, an implementation is shown which uses AAL3/4 from end to end. This is useful because AAL3/4 permits multiplexing of several connections with similar quality of service requirements to the same destinations in a single VC. This is useful, for example in a wide area network (WAN) environment where VPI and VCI values are at a premium. However, such values are unlikely to be at a premium in the wireless link between the terminal 2 and the switch 6. Thus, in that link, such multiplexing is not permitted. The terminal 2 creates all the ATM cells from a single PDU so that multiplexing occurs at a PDU level rather than at a cell level. The AUU parameter is used in the same way as described in connection with FIG. 2A to differentiate between cells of different PDUs.

In the switch 6, however, the AUU parameter is reset in the last cell of the PDU before onward transmission to the receiving terminal 10. This is because the receiving terminal 10 can determine which PDU is associated with which cell using the ALL3/4 protocol, i.e. internal multiplexing (at an ATM cell level) is permitted on the link after the ATM switch 6.

Additionally, since the terminal 10 can determine from the ALL3/4 protocol which ATM cells are associated with which PDUs, it is not necessary to transmit the last cell of a PDU containing an erroneous ATM cell. Thus, the signal sent by the ATM switch 6 to the terminal 2 when an erroneous ATM cell is detected simply causes the terminal 2 to cease sending any further cells from that PDU and to proceed to cells from the next PDU.

With reference to FIG. 2C, a hybrid solution may be desirable. The AAL5 protocol is more robust for the wireless link than the AAL3/4 protocol since it includes better error detection capabilities. Also as discussed above, assuming that there are enough VPI/VCI values, ATM multiplexing can be performed at the medium access control (MAC) level using the same channel for two or more ATM connections thus allowing a form of multiplexing on the wireless link between the terminal 2 and the switch 6. However, as discussed above, the AAL3/4 protocol allows multiplexing of several connections using the same VC and this may be desirable in the network 8.

To implement the hybrid solution, the ATM switch 6 implements all levels of the ATM protocol stack up to and including the ATM adaptation layer. In this layer, the ATM switch 6 is operable to perform a conversion from the AAL5 protocol to the ALL3/4 protocol for onward transmission of ATM cells to the terminal 10. During this conversion, the AUU parameter (which is set by the terminal 2 to indicate the end of a PDU) is reset before onward transmission to the terminal 10 (which as discussed above does not need the AUU parameter to be set to indicate boundaries of different PDUs since this is incorporated in the AAL3/4 protocol).

Preferably, the wireless connection between the terminal 2 and ATM switch 6 incorporates increased error detection and/or correction capabilities above that used for a fixed link. This is because the wireless link has an increased bit error rate (BER) compared to a wired link. Preferably sufficient coding is included to allow errors to at least be detected in the header and more preferably, for such errors to be corrected.

1. A method of transmitting non-real-time data over a wireless link from a terminal to an ATM switch comprising the steps of:
generating in the terminal, a plurality of ATM cells derived from a protocol data unit,
marking the last ATM cell of the protocol data unit,
sequentially transmitting the ATM cells over the wireless link,
determining in the ATM switch for each transmitted cell, whether that cell contains an error, and
sending an error message back to the terminal if an ATM cell is determined to contain an error, the terminal being arranged on receipt of the error message, to cease transmitting any remaining ATM cells of the protocol data unit from which the erroneous ATM cell was derived.

2. A method according to claim 1, wherein the last ATM cell of a protocol data unit is marked in the terminal, using the ATM layer user-to-user parameter in the header of the said last ATM cell.

3. A method according to claim 1 or claim 2, wherein the ATM cells are generated in the terminal by mapping from the protocol data unit to ATM cells using an AAL5 ATM adaptation protocol.

4. A method according to claim 3, wherein the ATM switch translates the AAL5 protocol data unit received as a plurality of ATM cells, into an AAL3/4 protocol data unit comprising a plurality of ATM cells mapped using an AAL3/4 ATM adaption protocol for onward transmission to another ATM switch or receiver.

5. A method according to claim 4, wherein the translation step includes resetting the ATM user-to-user parameter in the header of the last ATM cell of the AAL5 protocol data unit.

6. A method according to any preceding claim, wherein after receipt of the error message, the terminal transmits the last ATM cell of the protocol data unit from which the erroneous ATM cell was derived.

7. A method according to claim 1 or claim 2, wherein the ATM cells are generated in the terminal by mapping from the protocol data unit to ATM cells using an AAL3/4 ATM adaptation protocol.

8. A method according to claim 7, wherein the ATM cells generated in the terminal from the protocol data unit are all associated with the same virtual circuit.

9. A method according to claim 7 or claim 8, wherein the switch resets the ATM user-to-user parameter in the header of the last ATM cell of the protocol data unit before onward transmission to another ATM switch or receiver.

10. An ATM protocol stack for wireless ATM communications in which the physical layer below the ATM layer, has been adapted to include a radio access layer, the radio access layer including a medium access control protocol layer and a partial packet discard mechanism.

11. A data terminal including the ATM protocol stack of claim 10.

12. A data terminal according to claim 10, further including a wireless physical layer.

12. An ATM switch including the ATM protocol stack of claim 10.

13. An ATM switch according to claim 12, including an ATM layer and an ATM adaptation layer, the ATM adaptation layer being arranged to convert ATM cells mapped from a protocol data unit using the AAL5 protocol to ATM cells representing the same protocol data unit using an AAL3/4 mapping.

14. A method as described herein with reference to the drawings.

15. An ATM terminal constructed and arranged as described herein with reference to the drawings.

16. An ATM switch constructed and arranged as described herein with reference to the drawings.
